(19) United States
(12) Patent Application Publication
(10) Pub. No.: US 2006/0108886 A1
(43) Pub. Date: May 25, 2006

(54) Electric Motor, Especially Bell Armature Motor

(75) Inventors: Ulrich Kehr, Leinfelden-Echterdingen (DE); Reiner Bessey, Schonaich (DE)

Correspondence Address: GUDRUN E. HUCKETT DRAUDT, LONSSTR. 53, WUPPERTAL, 42289, DE

(73) Assignee: DR. FRITZ FAULHABER GMBH & CO. KG, Schonaich (DE)

(21) Appl. No.: 11/163,903

(22) Filed: Nov. 3, 2005

(30) Foreign Application Priority Data
Nov. 22, 2004 (DE) 202004018269.6
Dec. 6, 2004 (DE) 202004018822.8

(51) Int. Cl. H02K 49/00

(52) U.S. Cl. 310/103

(57) ABSTRACT

An electric motor has a rotor and a magnet system having at least one permanent magnet generating a magnetic field. At least one braking element made of ferromagnetic material is positioned at least partially within the magnetic field of the permanent magnet. The electric motor has a housing with a housing wall, and the magnetic field is generated between the permanent magnet and the housing wall. The permanent magnet is annular and surrounds a rotor shaft of the rotor at a spacing. The braking element is fixedly connected to the rotor or fixedly arranged on the housing.

### BACKGROUND OF THE INVENTION

The invention relates to an electric motor, in particular, a bell armature motor, comprising a rotor and a magnet system having at least one permanent magnet.

Electric motors in the form of bell armature motors that comprise a rotor that is not wound on onto an iron core but is comprised of a self-supported copper coil are known. A unique feature of such a configuration of an electric motor is that it has almost no locking moment. For many applications this is an advantage because the control properties of such a motor are excellent especially within the low rotary speed range. Moreover, such a motor has low inductance; this keeps the voltage peaks that occur during commutation at a low level. In the zero-current state, the rotor can be rotated at minimal torque, i.e., it has essentially no holding torque. For many electric actuators that are not combined with a self-locking gearbox this is a disadvantage because often it is desired that the electric actuator maintains its position even in the zero-current state.

### SUMMARY OF THE INVENTION

The invention has the object to design the electric motor of the aforementioned kind such that an actuator maintains its position even in the zero-current state.

This object is solved in accordance with the present invention for the aforementioned electric motor in that the electric motor has at least one braking element comprised of ferromagnetic material that is positioned at least partially within the magnetic field of the permanent magnet.

In the electric motor according to the invention, the braking element is positioned at least partially in the magnetic field of the permanent magnet. In this way, by means of a very simple configuration a holding torque is generated in the zero-current state. The electric motor can therefore be used excellently for drives, preferably electric actuators, that are not combined with a self-locking gearbox. By means of the holding torque the rotor is maintained in a defined position.

Further features of the invention result from the further claims, the description, and the drawings.

### BRIEF DESCRIPTION OF THE DRAWING

The invention will be explained in the following in more detail with the aid of several embodiments illustrated in the drawings.

FIG. 1 shows an axial section of an electric motor according to the invention in the form of a bell armature motor.

FIG. 2 is an axial section of the magnet system of the electric motor according to the invention according to FIG. 1.

FIG. 3 is a radial section of the magnet system of the electric motor according to the invention.

FIG. 4 shows an axial section of the rotor of the electric motor according to the invention.

FIG. 5 shows in plan view a first configuration of a braking disk of the electric motor according to the invention.

FIG. 6 shows in plan view a second configuration of a braking disk of the electric motor according to the invention.

FIG. 7 shows in plan view a third configuration of a braking disk of the electric motor according to the invention.

FIG. 8 shows an axial section of an electric motor according to the invention embodied as a brushless motor.

FIG. 9 is an axial section of an electric motor according to the invention embodied as a shrunk-on-disk motor.

FIG. 10 shows in axial section another embodiment of the electric motor according to the invention in the form of a bell armature motor.

FIG. 11 shows in perspective illustration a first embodiment of a braking element of the electric motor according to the invention.

FIG. 12 shows in perspective illustration a second embodiment of a braking element of the electric motor according to the invention.

FIG. 13 shows individual elements for manufacturing a braking element.

### DESCRIPTION OF THE PREFERRED EMBODIMENTS

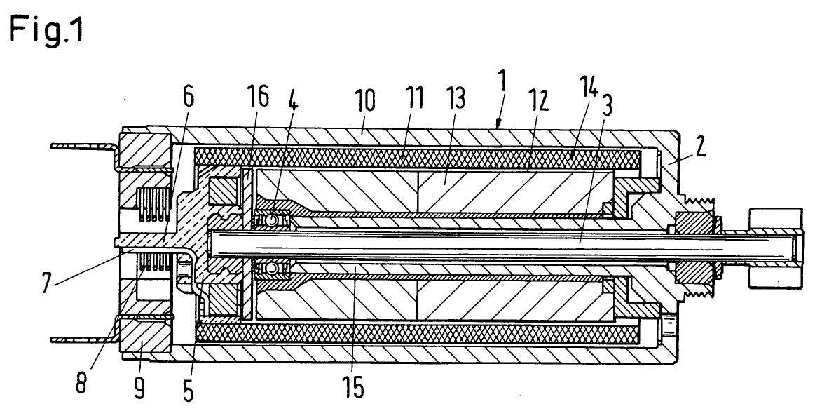

The electric motor according to FIGS. 1 through 7 is embodied as a bell armature motor of conventional configuration and has a housing 1 having a rotor shaft 3 rotatably supported in its housing bottom 2. Within the housing 1 the rotor shaft 3 is rotatably supported by an additional bearing 4. On the end of the rotor shaft 3 positioned within the housing 1 a rotor body 5 comprised of electrically insulating material is provided; it has a central axial projection 6 on which the collector laminations 7 in the form of copper or stainless steel laminations are positioned. As is known in the art, brushes 8 rest against the collector laminations 7; the brushes are secured in a housing lid 9 that is comprised of electrically insulating material. It is inserted into the end of the housing 1 facing away from the housing bottom 2 and is fixedly connected thereto.

On the inner wall of the housing wall 10 a coil 11 is arranged that extends about most of the length of the housing wall 10 and is attached with its end facing away from the housing bottom 2 to the rotor body 5.

The coil 11 surrounds with formation of an annular gap 12 an annular permanent magnet 13 that is part of a magnet system 14. The permanent magnet 13 is shorter than the coil 11 that surrounds it and projects past both ends thereof. Instead of the single annular magnet 13, it is also possible to provide several annular magnets contacting one another.

The rotor shaft 3 is surrounded with radial play by an annular (cylindrical) wall 15 that is formed as a unitary part of the housing bottom 2 and supports on the end positioned within the housing 1 the bearing 4 for the rotor shaft 3. The permanent magnet 13 is attached to the annular wall 15.

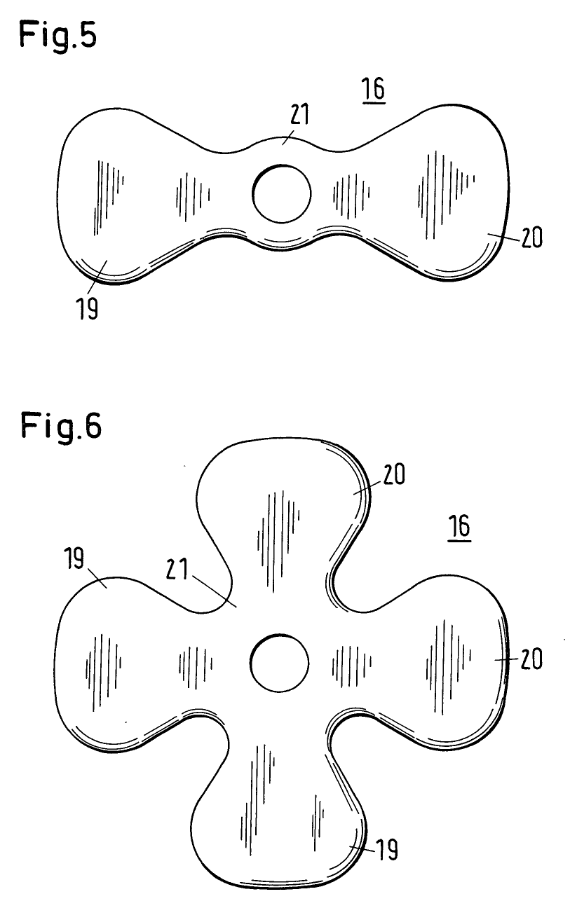

In the area between the annular permanent magnet 13 and the rotor body 5 a braking element 16 is mounted fixedly on the rotor shaft 3 and is comprised of ferromagnetic material. It is configured as a flat disk that can have different circumferential shapes, as will be explained in connection with FIGS. 5 through 7 in more detail.

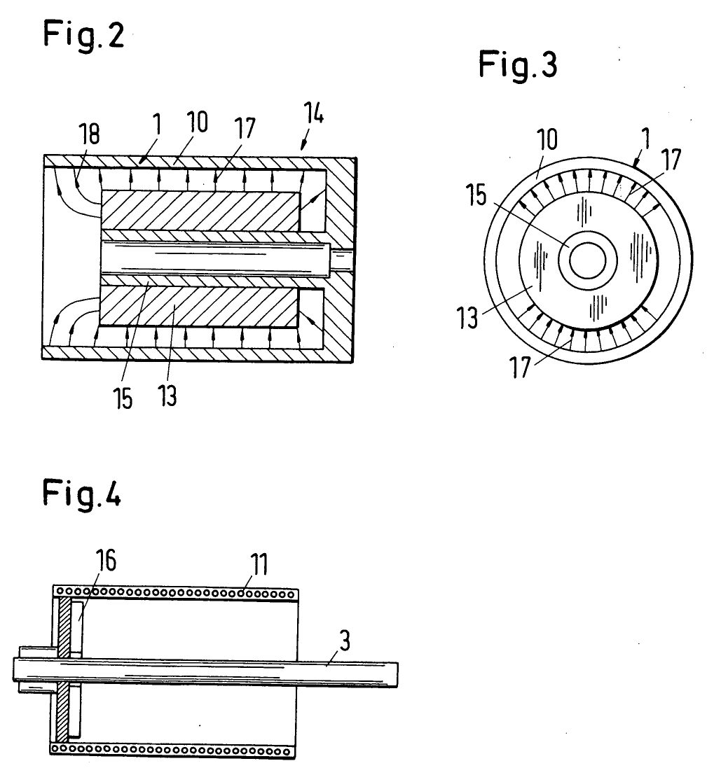

FIG. 2 shows the course of the magnetic field in the magnetic system 14 of the electric motor. Between the magnet 13 and the housing 1 there exists a magnetic field 17. The magnetic field lines 18 that exit at the end face of the permanent magnet 13 facing the braking element 16 (FIG. 2) interact with the braking element 16 that projects into this area of the magnetic field lines 18.

As can be seen in FIG. 3, the housing wall 10 is cylindrical. The permanent magnet 13 is arranged such that its north pole is positioned within one half of the ring and its south pole in the other half of the ring (FIG. 3). Accordingly, the lines of the magnetic field 17 extend from the north pole radially to the housing wall 10 and from there radially back to the south pole of the permanent magnet 13.

FIG. 4 shows the rotor shaft 3 on which the braking element 16 is positioned; it extends into close proximity of the cylindrical coil 11 that surrounds the rotor shaft 3 at a spacing.

The braking element 16 is advantageously disk-shaped so that it requires only minimal mounting space. Of course, the braking element 16 can also have a shape that differs from that of a disk. The braking element 16 is positioned such on the rotor shaft 3 that it is positioned in the magnetic field 17 of the permanent magnet 13 of the stator.

In the embodiment according to FIG. 5, the braking element 16 is of a two-vane configuration. It has two opposed vanes 19, 20 that project radially from the center part 21 seated on the rotor shaft 3 and are spaced at an angular spacing of 180° relative to one another. The vanes 19, 20 widen from the center part 21 in the direction toward their free ends. Both vanes 19, 20 are advantageously of identical configuration. As a result of the two-vane configuration of the braking element 16 two locking positions for each rotor shaft rotation result for the illustrated two-pole magnet 13 when rotating the rotor shaft 3. The rotor shaft 3 can therefore be safely secured in two defined positions in the zero-current state of the electric motor.

The braking element 16 according to FIG. 6 has four vanes 19, 20 projecting from the circular center part 21. They are arranged at an angular spacing of 90° about the circumference of the center part 21 and extend radially outwardly. The vanes 19, 20 widen continuously in the direction toward their free ends. The vanes 19, 20 are again configured such that they project in the mounted state of the braking element 16 into the area of the magnet field 17 of the permanent magnet 13 of the stator. The vanes 19, 20 are again advantageously of identical configuration and are positioned in a common plane. Because of the four vanes 19, 20, four locking positions are provided for each rotor revolution in the case of the two-pole permanent magnet 13. The rotor shaft 3 can therefore be secured in four positions when the electric motor is switched off.

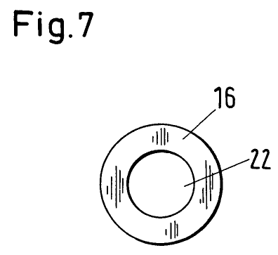

The braking element 16 according to FIG. 7 is configured as an annular disk that is provided with a central opening 22 for securing on the rotor shaft 3. The outer diameter of the braking element 16 is minimally smaller than the inner diameter of the coil 11. In this configuration, the holding torque is generated by the hysteresis losses.

The annular disk 16 can also be comprised of magnetically hard magnetizable material. In this case, the holding torque is generated by locking as in the preceding embodiment.

The illustrated configurations of the braking element 16 are only examples. The braking element 16 can be configured as a fanned disk that has not only two or four but can have only a single, three or more than four vanes so that the rotor shaft 3 is secured in corresponding positions when the electric motor is at zero current.

The braking element 16 is advantageously produced from a magnetically semi-hard material with high remanence induction and low coercive field strength. The remanence induction can be, for example, in the range of between approximately 0.5 T and approximately 1.5 T and the coercive field strength can be, for example, in the range of approximately 2 kA/m to approximately 66 kA/m.

The braking element 16 can also be made from a magnetically hard magnetizeable material.

Finally, the braking element 16 can also be comprised of a magnetically soft material, for example, transformer sheet.

In a non-represented configuration the braking element 16 is a ring that is mounted on a rotor winding that is advantageously provided in its developed view with at least one tooth. Depending on the number of teeth of this ring, a matching number of holding positions are provided for a rotor revolution when the electric magnet is at zero current.

The electric motor has been explained in connection with a bell armature motor. The braking element 16 can also be used in other types of electric motors, for example, in brushless electric motors and shrunk-on-disk motors.

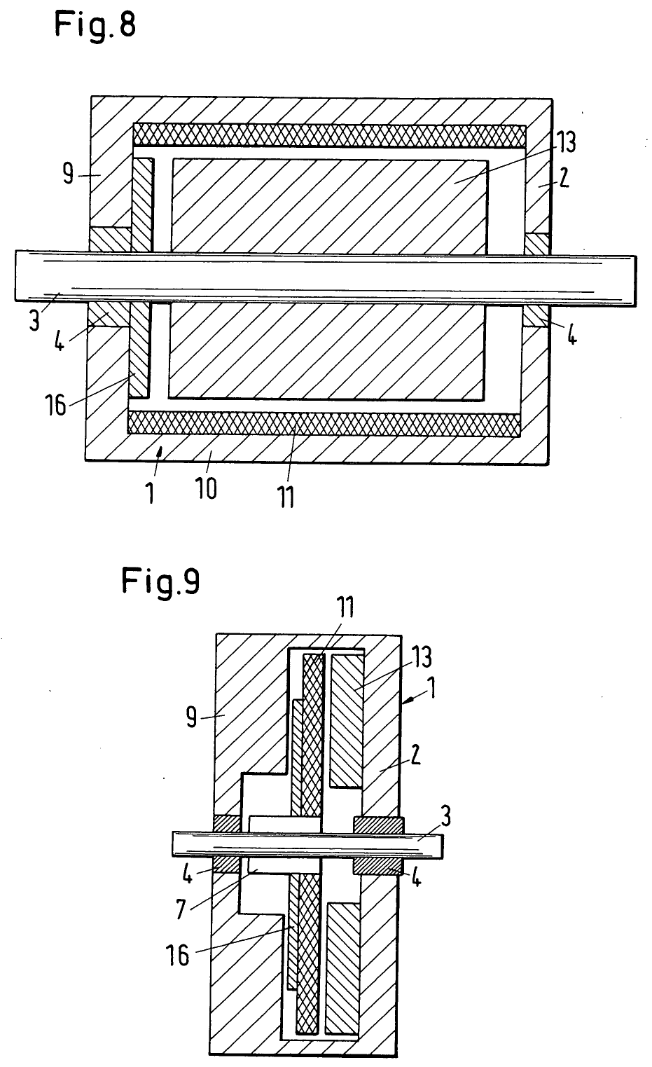

FIG. 8 shows in axial section and in a simplified illustration a brushless electric motor with rotor shaft 3 that penetrates the housing 1 axially and is rotatably supported in the housing bottom 2 as well as the housing lid 9 by means of a bearing 4, respectively. The coil 11 is attached to the inner wall of the housing wall 10 that extends between the housing bottom 2 and the housing lid 9. The coil 11 surrounds at a spacing the permanent magnet 13 that is mounted fixedly on the rotor shaft 3.

On the inner side of the housing lid 9 a braking element 16 surrounding the rotor shaft 3 is positioned and is configured as a flat disk; it can have a configuration in accordance with FIGS. 5 to 7. The braking element 16 interacts with the axially acting magnetic field 17 (FIG. 2) of the permanent magnet 13 in the way described above. By means of the braking element 16 it is possible to secure the rotor shaft 3 in defined positions when the electric motor is switched off.

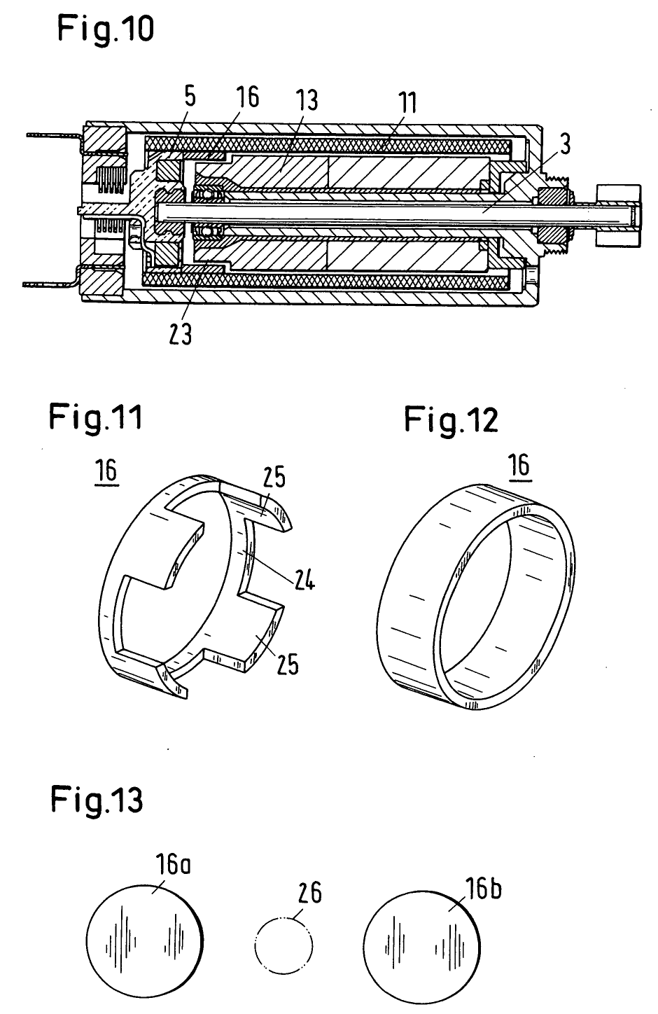

The braking element 16 can also be configured in such a way—to be disclosed in connection with FIG. 10 in the following—that it interacts with the diametrically acting magnetic field 17 (FIGS. 2 and 3).

The electric motor according to FIG. 9 is configured as a shrunk-on-disk motor and has a rotor shaft 3 that penetrates the housing 1 axially. In the housing bottom 2 and the housing lid 9 the rotor shaft 3 is rotatably supported by means of a bearing 4, respectively. On the inner side of the housing bottom 2 the permanent magnet 13 is positioned that is configured as an annular disk and surrounds the rotor shaft 3 at a spacing. Opposite the permanent magnet 13, the coil 11 is positioned at an axial spacing thereto; the coil is disk-shaped and is fixedly attached to the rotor shaft 3. On the side of the coil 11 facing away from the permanent magnet 13 the braking element 16 is located and is also connected fixedly to the rotor shaft 3. The coil 11 and the braking element 16 are seated on the collector 7 provided on the rotor shaft 3.

When the motor is at zero current, by means of the braking element 16 that is configured in accordance with FIGS. 5 to 7, the rotor shaft 3 can be held in the described way precisely in the respective positions that depend on the configuration of the braking element 16.

The electric motor according to FIG. 10 differs from the electric motor according to FIG. 1 only in regard to the configuration of the braking element 16. It is not configured as a disk but as a ring that rests against the inner wall of the coil 11. The braking element 16 is attached to the insulating body 5 and projects into an end face recess 23 of the permanent magnet 13.

The annular braking element 16 is positioned in the diametrically acting magnetic field 17 (FIGS. 2 and 3) of the permanent magnet 13. In the described way, the rotor shaft 3, when the electric motor is switched off, can be precisely held in the respective position.

FIG. 11 shows an embodiment of an annular braking element 16. It has a circular annular body 24 from which tongues 25 project axially. They are uniformly distributed about the circumference of the annular body 24. In the embodiment, the braking element 16 has four such tongues 25 that are spaced at an angular spacing of 90° from one another. The rotor shaft 3 can thus be secured in defined positions when the electric motor is switched off.

It is also possible that fewer than four or more than four tongues 25 project from the annular body 24 so that the rotor shaft 3 is secured in the corresponding positions.

The braking element 16 according to FIG. 11 is produced advantageously from a magnetically semi-hard material or also from a magnetically soft material.

The braking element 16 according to FIG. 12 is configured as a ring that is comprised of a magnetically hard magnetizeable material. The holding torque is produced by locking in such a ring-shaped braking element 16. When the braking element 16, on the other hand, is not comprised of magnetically hard magnetizeable material, the holding torque is produced by hysteresis losses.

FIG. 13 finally shows the possibility of producing the braking element 16 of discrete parts 16a, 16 b. In the illustrated embodiment, the braking element parts 16a, 16b are comprised of two disks that are advantageously of the same size and arranged about an imaginary center 26. The two parts 16a, 16b can be attached, for example, by gluing, to the underside of the insulating body 5 in place of the disk-shaped braking element 16 according to FIG. 1. The center 26 in this case is the axis of the rotor shaft 3.

In the embodiments according to FIGS. 8 and 9, the disk-shaped braking element 16 can be replaced by discrete braking element parts 16a, 16b. In the electric motor according to FIG. 8, these braking element parts 16a, 16b are attached to the housing bottom 9 (magnetic yoke) and, in the electric motor according to FIG. 9, to the disk-shaped coil 11 in such a way that the imaginary center 26 forms the axis of the rotor shaft 3.

While specific embodiments of the invention have been shown and described in detail to illustrate the inventive principles, it will be understood that the invention may be embodied otherwise without departing from such principles.

What is claimed is:

1. An electric motor comprising:
a rotor;
a magnet system having at least one permanent magnet generating a magnetic field;
at least one braking element comprised of ferromagnetic material that is positioned at least partially within the magnetic field of the at least one permanent magnet.

2. The electric motor according to claim 1, wherein the at least one braking element is fixedly connected to the rotor.

3. The electric motor according to claim 1, comprising a housing, wherein the at least one braking element is fixedly arranged on the housing.

4. The electric motor according to claim 1, comprising a housing having a housing wall, wherein the magnetic field is generated between the at least one permanent magnet and the housing wall.

5. The electric motor according to claim 1, wherein the at least one permanent magnet is annular and surrounds a rotor shaft of the rotor at a spacing.

6. The electric motor according to claim 5, comprising a housing having a cylindrical wall that surrounds the rotor shaft, wherein the at least one permanent magnet is mounted on the cylindrical wall.

7. The electric motor according to claim 6, further comprising at least one bearing rotatably supporting the rotor shaft in the cylindrical wall.

8. The electric motor according to claim 6, wherein the at least one braking element is fixedly mounted on the rotor shaft outside of the cylindrical wall.

9. The electric motor according to claim 1, wherein the at least one permanent magnet is surrounded by at least one coil, wherein between the at least one permanent magnet and the at least one coil an air gap is formed.

10. The electric motor according to claim 1, wherein the at least one permanent magnet is positioned opposite at least one coil.

11. The electric motor according to claim 1, wherein the at least one braking element is a disk.

12. The electric motor according to claim 1, wherein the at least one braking element is a fanned disk.

13. The electric motor according to claim 12, wherein the fanned disk has at least one vane.

14. The electric motor according to claim 12, wherein the fanned disk has two vanes that are spaced at an angular spacing of 180° from one another.

15. The electric motor according to claim 12, wherein the fanned disk has several vanes that are spaced at an angular spacing of 90° from one another.

16. The electric motor according to claim 1, wherein the at least one braking element is a ring.

17. The electric motor according to claim 16, wherein the at least one braking element has at least one tongue projecting axially from an annular body of the ring.

18. The electric motor according to claim 1, wherein the at least one braking element is made from transformer sheet.

19. The electric motor according to claim 1, wherein the at least one braking element is comprised of a magnetically semi-hard material having high remanence induction and low coercive field strength.

20. The electric motor according to claim 19, wherein the remanence induction is between approximately 0.5 T and approximately 1.5 T.

21. The electric motor according to claim 19, wherein the coercive field strength is between approximately 2 kA/m and approximately 66 kA/m.

22. The electric motor according to claim 1, wherein the at least one braking element is comprised of magnetically hard magnetizeable material.

23. The electric motor according to claim 1, wherein the at least one braking element is a ring seated on a rotor winding of the rotor.

24. The electric motor according to claim 23, wherein the ring has at least one tooth in a developed view.

25. The electric motor according to claim 1, wherein the at least one braking element is comprised of several parts.
